(19) United States
(12) Patent Application Publication
(10) Pub. No.: US 2024/0275016 A1
(43) Pub. Date: Aug. 15, 2024

(54) Apparatus

(71) Applicant: Nokia Technologies Oy, Espoo (FI)

(72) Inventor: Mikko KOMULAINEN, Oulu (FI)

(21) Appl. No.: 18/441,044

(22) Filed: Feb. 14, 2024

(30) Foreign Application Priority Data
Feb. 15, 2023 (EP) 23156700.9

(51) Int. Cl. H01P 3/16; H01P 3/08; H01Q 1/22

(52) U.S. Cl. CPC H01P 3/16; H01P 3/081; H01Q 1/22

(57) ABSTRACT

There is provided an apparatus which includes: a waveguide arranged to guide electromagnetic waves, the waveguide including at least one conductive wall enclosing a waveguide path, wherein the waveguide is gas-filled, and a component with a conductive surface. The waveguide is integrated with the component, wherein the waveguide has at least part of the at least one conductive wall shared with the conductive surface of the component and at least another part of the at least one conductive wall that is non-shared.

### FIELD

The present application relates to an apparatus for a communication system. In particular, to an apparatus with a waveguide integrated with a component.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus comprising: a waveguide arranged to guide electromagnetic waves, the waveguide comprising at least one conductive wall enclosing a waveguide path, wherein the waveguide is gas-filled; and a component with a conductive surface, wherein the waveguide is integrated with the component, wherein the waveguide has at least part of the at least one conductive wall shared with the conductive surface of the component and at least another part of the at least one conductive wall that is non-shared.

In an example, the at least part of the at least one conductive wall shared with the component comprises: the waveguide attached to the component so that at least part of a wall of the component is in contact with the at least part of the at least one conductive wall of the waveguide, and the waveguide attached to the component so that the at least part of the wall of the component forms the at least part of the at least one conductive wall of the waveguide.

In an example, the waveguide comprises a plurality of conductive walls, wherein the at least part of the at least one conductive wall shared with the component comprises: at least one wall of the plurality of conductive walls that is shared with the conductive component, and wherein the at least another part of the at least one conductive wall that is non-shared comprises: at least one wall of the plurality of conductive walls that is non-shared.

In an example, the component is one of: an electromagnetic shield, a lightguide, an audioguide, a heatsink, a frame for a display, an antenna, an antenna cable, a printed circuit board, a radio frequency cable, a battery, a connector, a frame for a connector, a frame for a camera, a frame for a battery, a metallic support frame, a support structure, a holder, a cover structure, a protection structure, a part used to protect the component.

In an example, when the conductive component is an electromagnetic shield, the waveguide is integrated with the electromagnetic shield, wherein the waveguide has at least part of the at least one conductive wall shared with the electromagnetic shield, and wherein at least another part of the at least one conductive wall is non-shared, such that at least part of a conductive wall is shared between the waveguide and the electromagnetic shield.

In an example, the waveguide is one of: enclosed within the electromagnetic shield, partially enclosed within the electromagnetic shield, located outside of the electromagnetic shield, partially located outside of the electromagnetic shield.

In an example, the electromagnetic waves include at least one of: radio frequency waves, intermediate frequency waves, millimetre waves, and microwaves.

In an example, the waveguide is arranged to guide light and/or sound waves as well as the electromagnetic waves.

In an example, the waveguide comprises at least one aperture in the at least one conductive wall, the at least one aperture arranged to be used as at least one antenna.

In an example, the waveguide is arranged as an open-ended waveguide, the open-end of the waveguide arranged to be used as an antenna.

In an example, the apparatus comprises a feed probe which is arranged to be inserted into an opening of the waveguide.

In an example, the apparatus comprises a substrate, wherein the conductive component is mounted to the substrate.

In an example, the waveguide is integrated with the substrate, the waveguide having at least part of the at least one conductive wall shared with the substrate.

In an example, the waveguide attached to the substrate so that the at least part of a wall of the substrate forms at least part of at least one conductive wall of the waveguide.

In an example, the at least part of the at least one conductive wall that is shared with the substrate comprises at least one aperture, the at least one aperture arranged to be used as at least one antenna.

In an example, the substrate is a printed circuit board.

In an example, the waveguide is air-filled.

In an example, the waveguide has a circular shaped cross-section, and is air-filled.

In an example, one of: the apparatus is for a user device, the apparatus is comprised in the user device, and the apparatus is the user device.

According to an aspect, there is provided a user device comprising: a waveguide arranged to guide electromagnetic waves, the waveguide comprising at least one conductive wall enclosing a waveguide path, wherein the waveguide is gas-filled; and a component with a conductive surface, wherein the waveguide is integrated with the component, wherein the waveguide has at least part of the at least one conductive wall shared with the conductive surface of the component and at least another part of the at least one conductive wall that is non-shared.

According to an aspect there is provided an apparatus comprising: a waveguide arranged to guide electromagnetic waves, the waveguide comprising at least one conductive wall enclosing a waveguide path; and two mechanical parts, wherein the waveguide is arranged between the two mechanical parts, to seal between the two mechanical parts.

In an example, the waveguide is in contact with both of the two mechanical parts.

In an example, the apparatus also comprises sealing material, wherein the sealing material is arranged between the two mechanical parts, and wherein the sealing material is in contact with one of the two mechanical parts and the waveguide.

In an example, the sealing material comprises a dielectric gasket.

In an example, the waveguide is one of: gas-filled, air-filled and dielectric filled.

An electronic device may comprise an apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### LIST OF ABBREVIATIONS

BS: Base Station
EMC: Electromagnetic compatibility
EMI: Electromagnetic interference
GHz: Gigahertz
IF: Intermediate frequency
NR: New Radio
NW: Network
PCB: Printed circuit board
RF: Radio frequency
THz: Terahertz
UE: User Equipment
UL: Uplink
WG: Waveguide
3GPP: 3^{rd} Generation Partnership Project
5G: 5^{th} Generation
6G: 6^{th} Generation
5GS: 5G System

### DESCRIPTION OF FIGURES

Embodiments will now be described, by way of example only, with reference to the accompanying Figures in which:

FIG. 1 shows a schematic representation of waveguides;

FIG. 2 shows a graphical representation of a result of an example simulation to illustrate waveguide insertion loss compared to microstrip line loss;

FIG. 3 shows a schematic representation of a waveguide with components arranged to feed a radio frequency signal into the waveguide, wherein the waveguide and components are unassembled;

FIG. 4 shows a schematic representation of the waveguide with components according to FIG. 3, wherein the waveguide and components are assembled together;

FIGS. 5A and 5B show schematic representations of implementations for waveguide electric field probe feeds, in un-assembled and assembled views respectively;

FIGS. 6A and 6B show schematic representations of a lightguide and an audio guide respectively;

FIG. 7 shows a schematic representation of a waveguide integrated with an electromagnetic shield;

FIGS. 8A-8D show schematic representations of waveguides integrated with electromagnetic shields, in four different configurations;

FIGS. 9A-9D show schematic representations of waveguides integrated with electromagnetic shields, with apertures in a waveguide wall;

FIGS. 10A-10D show schematic representations of waveguides integrated with electromagnetic shields, with apertures in a waveguide wall;

FIGS. 11A and 11B show schematic representations of waveguides integrated with electromagnetic shields, with apertures formed in in a waveguide wall shared with a substrate;

FIG. 12A shows a schematic representation of a radio frequency/intermediate frequency waveguide integrated with a lightguide;

FIG. 12B shows a schematic representation of a radio frequency/intermediate frequency waveguide integrated with an audio guide;

FIGS. 13A and 13B show schematic representations of waveguides being used for mechanical sealing; and

FIG. 14 shows a schematic representation of a terminal.

### DETAILED DESCRIPTION

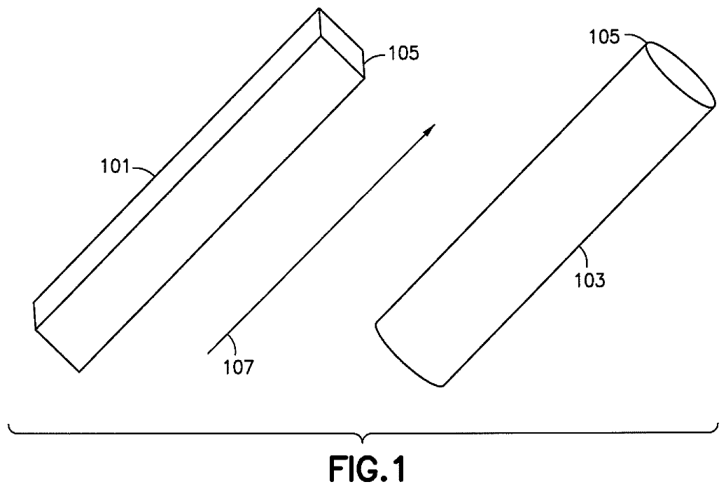

Before explaining in detail some examples of the present disclosure, certain general principles of some components used in wireless and wired communication systems, as well as in mobile communication devices, are briefly explained with reference to FIGS. 1 to 6 to assist in understanding the technology underlying the described examples.

Integrating electronics into an ever-smaller volume is a key enabler for the small size, and high functionality, of modern wireless communication devices. Increased electronics integration density has been achieved by making individual components smaller, and by integrating more functionality into each component. Electronics miniaturization has been driven by the evolution of semiconductor technologies, and in particular silicon technologies. However, it is also important to be able to miniaturize non-silicon components such as antennas, batteries, connectors, cables, etc.

A trend in wireless communications is that of seeking the use of ever higher frequencies from the spectrum. 3GPP 5G, or New Radio (NR), uses new frequency ranges including, for example, 4.2 gigahertz (GHz), 4.9 GHZ and 24-48 GHz which are pushing the spectrums used for 3GPP access to higher frequencies, compared to previous generations. Moreover, frequency ranges at 48 GHz, 60 GHz, 100 GHz and 1+ terahertz (THz) are subject to current feasibility studies for use in the next generations of wireless communication systems (e.g. 5G advanced, 6G, etc). At frequencies between 60 and 100 GHz and beyond, radio frequency (RF) interconnections and antenna technologies that are used at lower frequencies are not always applicable or suitable. Technologies such as RF micro co-axial cables, dipole and patch antennas and their derivatives are subject to very high RF signal losses at frequencies above 60 GHz. This is due to co-axial cables getting more lossy as the operating frequency increases. Power handling may also be a factor for the signal losses. One or both of these aspects may lead to the use of waveguides over co-axial cables. At these higher frequencies, the use of waveguide structures for RF/intermediate frequency (IF) signal interconnect transfer and interconnections, and for antenna solutions, are useful because of their lower signal losses compared to alternatives.

Furthermore, waveguides may be selected over co-axial cables as, in co-axial cables, the distance between an outer and inner conductor is an important parameter for the impedance of the co-axial cable. Air-filled co-axial cables are difficult to produce as there is a need to control the distance between the outer and inner conductors. The distance may be controlled by arranging dielectric material between the conductors. Dielectric material scales the wavelength and co-axial cable dimensions lower compared to their air-filled counterpart.

In addition, waveguide structures at these frequencies are suitably sized to allow them to be integrated into user devices (e.g. mobile devices, user equipments (UEs), personal computers, tablets, etc). As an example, suitable cross-sectional dimensions for an air-filled rectangular waveguide, with a 75 GHz cut-off frequency, is 2 millimetres (mm)×2 mm. This size for a waveguide, as an example, would be small enough to be included in such user devices.

FIG. 1 shows a schematic representation of waveguides. A waveguide (WG) is a structure used to guide, or transfer, electromagnetic (EM) waves. A first WG 101 has a rectangular structure. The rectangular structure refers to the shape of the walls of the first WG 101, which forms a rectangle with a cross-section view. A second WG 103 has a circular structure. The circular structure refers to the wall of the second WG 103, which forms a circle with a cross-section view.

The structures of the first and second WGs 101, 103 may comprise rectangular or circular (respectively) dielectric material surrounded by the walls or wall 105. The wall(s) may comprise solid metal, or coated be in metal or another conductive material. In this way, the first WG 101 has four walls, and the second WG 103 has one wall. This is assuming that the two ends of the WGs 101, 103 are open (i.e. open ended).

In some examples, the dielectric material is a gas. The gas may be, for example, air. In this way, the waveguide is empty/hollow. However, in other examples the WGs 101, 103 may comprise other dielectric material fills.

Waveguides may also have apertures/holes in the wall(s) 105 of the WGs (not shown). The apertures may be used as antennas. The apertures may be used for providing non-conductive access for a feed pin, probe, or other electronic components suitable for waveguides. In many of the following examples, waveguides are used to transfer RF/IF signals inside a device. In this example, the first 101 and second WGs 103 are arranged to guide RF/IF in the direction as indicated by the arrow 107. In some examples, signals are sent bi-directionally through the WGs 101, 103, for receive and transmit requirements. It should be understood that waveguide structures can be also used as antennas.

In other examples, any other shape for cross-sections of WGs are used. For example, elliptical shaped, or square shaped WGs. The WGs 101, 103 of FIG. 1 have a straight path. In other examples, WGs have any shaped path. WGs may be arranged to transfer/guide EM waves along any suitable path.

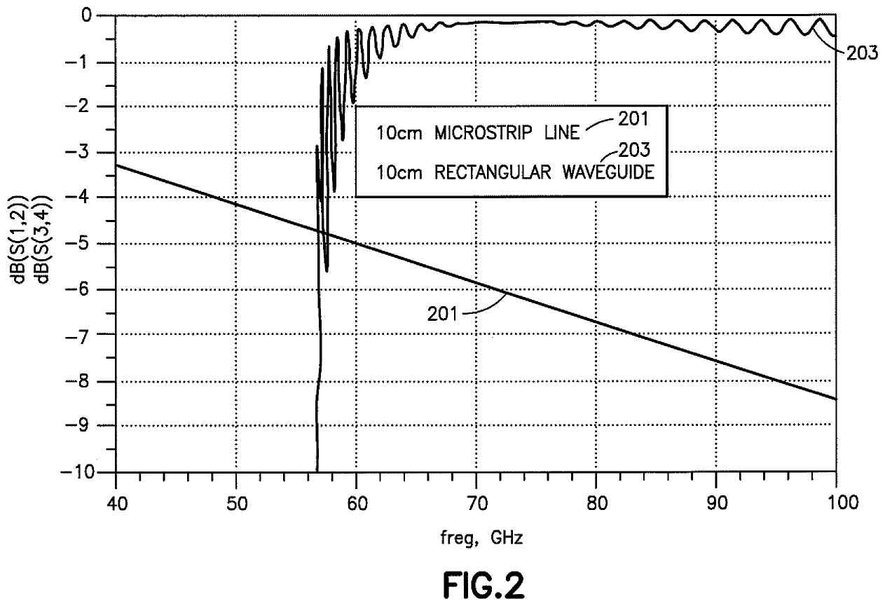

FIG. 2 shows a graphical representation of a result of an example simulation to illustrate waveguide insertion loss compared to microstrip line loss.

In this example, there are two simulation models. A first simulation is for 5 cm long microstrip line built on low RF loss PCB (εr=4.4, PCB thickness=0.3 mm, dielectric loss 0.001@60 GHz, linewidth 0.53 mm, conductor material is copper). A second simulation is for 5 cm long air-filled rectangular waveguide with dimensions 2.6 mm×2.6 mm, wherein the walls of the waveguide are made from copper.

The graphical representation has frequency in GHz on the x-axis, and decibels (dB) on the y-axis. The label of dB(S(1, 2)) on the y-axis is associated with the microstrip line, and the label of dB(S(3, 4)) on the y-axis is associated with the rectangular waveguide.

The results of the simulation show a first line, labelled 201, which is the response of the microstrip line. There is also provided a second line, labelled 203, which is associated with the rectangular waveguide. It can be seen in FIG. 2 that simulated insertion losses show that, above the cut-off frequency of ˜60 GHz, the rectangular waveguide shows considerably lower insertion losses compared to the same length of planar microstrip line. Therefore, for frequencies of ˜60 GHz and above, it is apparent that rectangular waveguides are more suitable than microstrip lines.

Circular WGs provide the least loss compared to rectangular and elliptical WGs. An air-filled dielectric cavity, within the WG, as a dielectric medium has the least losses, compared to other dielectrics. WGs have a narrower bandwidth than, for example, co-axial cables. This is due to the cross-sectional dimensions, in particular the broad dimension of a rectangular WG. The broad dimension gives rise to the cut-off wavelength which is equal to 2 times the broad dimension. Direct current (DC) cannot be provided through a WG.

In order to use a waveguide for RF signal transfer, an RF signal is input into the waveguide, and then output out of the waveguide. For this purpose, the waveguide is often mounted to a printed circuit board (PCB) that is hosting the radio frequency electronics. Instead of the PCB, the substrate may be, for example, a semiconductor, ceramic substrate, or the like. The substrate may be, for example, a PCB of a device, a multichip of a single chip module used in the device, or suitable electronics component used in the device.

In some examples, a waveguide is not mounted to a PCB, or any other substrate. For example, for larger WGs, in radar applications, large metal tubes are often used as WGs which do have a PCB. The feeding of the signal into the WG may be via a cable attached to the outside of the WG, the centre conductor of which protrudes through an aperture into the space within the WG. In some cases, due to the high power being used, there will not be any cables for the feed, and instead the signals are entirely handled within the WG. In examples whereby a PCB substrate is used, flexible, semi-flexible, and/or combined rigid and flexible/semi-flexible PCBs may be used.

A feed probe and WG may be manufactured using moulded interconnect device (MID) technology which uses a two-shot moulding. One shot is a plateable plastic, and the other shot is a non-plateable plastic. The conductive parts are produced by the plateable plastic shot(s) and air cavities being provided in the mould tool by having retractable metal tooling to prevent the molten plastics from flowing into specific areas/volumes. The 2-shot MID part is then put through a standard plating process to plate the plateable plastics surfaces, which remain available to the required plating chemicals. Laser direct structuring (LDS) may also be another technique which could be used to manufacture a plated plastic part which provides a WG, with or without the feed as part of the LDS part. Other similar manufacturing technologies may also apply. In other examples, other suitable technologies are used for the manufacturing.

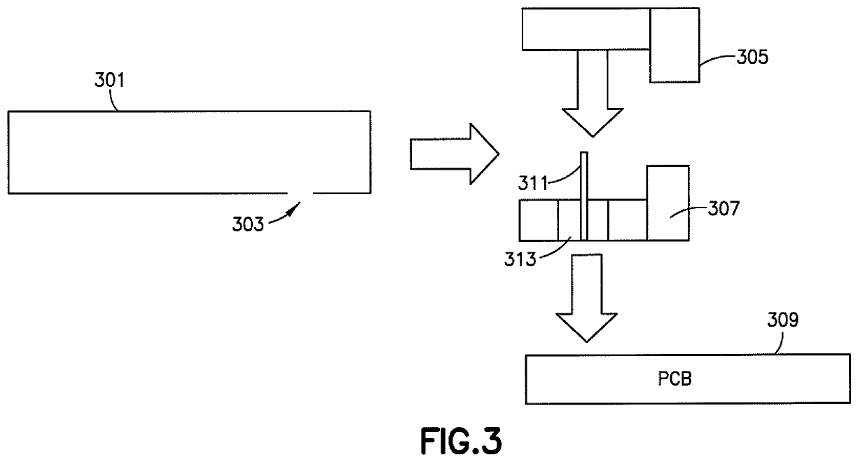

FIG. 3 shows a schematic representation of a waveguide with components arranged to feed an RF signal into the waveguide, wherein the waveguide and components are unassembled.

There is provided a waveguide 301 structure wherein the waveguide 301 has an opening 303 in a conductive wall. There is also provided an upper and a lower adapter part 305, 307 made of a conductive material. There is also provided a PCB 309 hosting radio electronics. The PCB 309 is the substrate that the waveguide 301 is intended to be mounted to. The lower adapter part 307 has a conductive feed probe 311 and a dielectric opening 313.

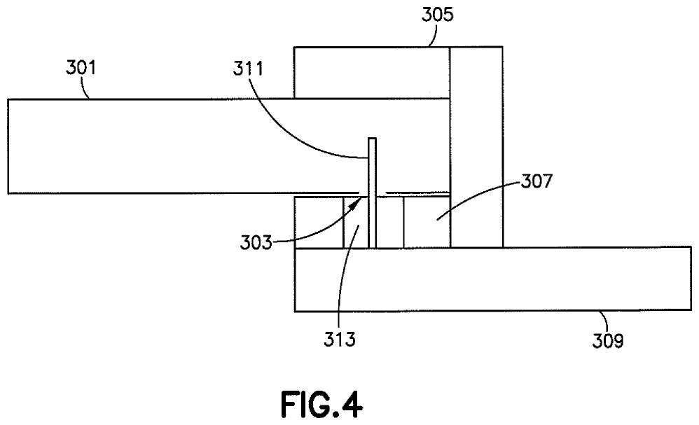

FIG. 4 shows a schematic representation of the waveguide with components according to FIG. 3, wherein the waveguide and components are assembled together. The same labelling is used in FIG. 4 as is used in FIG. 3, for the same parts/components.

The final assembled system is illustrated in FIG. 4, whereby the waveguide 301, the upper and lower adapter parts 305, 307, and the PCB 309 are connected together. The upper and lower adapter parts 305, 307 connect to each other and to the waveguide 301, for example, with screws or bolts (not shown). Alternatively, a press fit, adhesive, solder joint or other joints, and combinations thereof, may be used to connect the parts 305, 307. The adapter parts 305, 307 and the waveguide 301 assemble/connect to the PCB 309 with, for example, screws or bolts. The screws or bolts may be same as the screws/bolts used to mount the waveguide 301 to the adapter parts 305, 307. Alternatively, the adapter parts 305, 307 may be soldered to the PCB 309. Mounting the adapter parts 305, 307 to the PCB 309 is such that the feed probe 311 mounts to an RF signal pad at the PCB 309, and the lower adapter part 307 mounts to a PCB ground. RF signals couple from the adapter feed probe 311 to the waveguide 301. In this manner, RF signals are fed to (or from) the waveguide 301 using the probe 311 i.e., electric field feed.

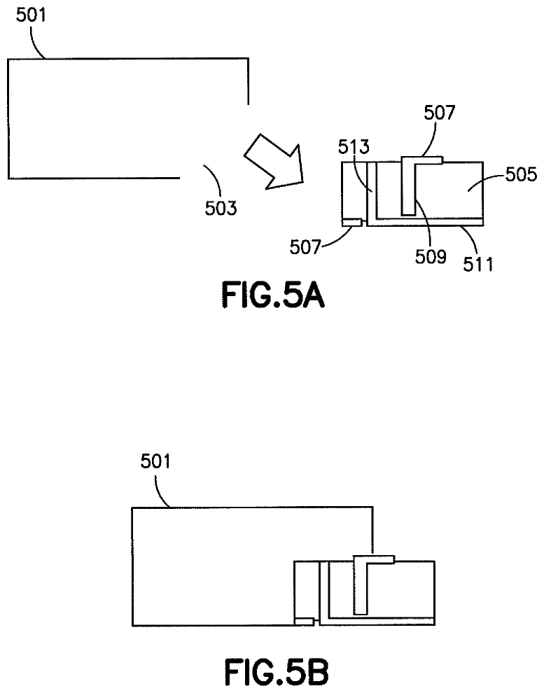

FIGS. 5A and 5B show schematic representations of implementations for waveguide electric field probe feeds, in un-assembled and assembled views respectively.

There is provided a waveguide 501, with an opening 503 in a wall of the waveguide 501. There is a multilayer substrate 505 (e.g. a PCB), which comprises at least one solder pad 507, at least one vertical ground via 509, a transmission line 511, and a vertical via 513 which is configured to be a waveguide feed probe. FIG. 5A shows the multilayer substrate 505 away from the waveguide 501. FIG. 5B shows the assembled view, whereby the multilayer substrate 505 is inserted into the opening 503. When the multilayer substrate 505 is inserted into the opening 503, RF signals can be provided into the waveguide 501 via the vertical via 513 which is configured to be a waveguide feed probe.

The method of feeding RF signals into waveguides as described with FIGS. 3 and 4 is the same for the system of FIGS. 5A and 5B. A difference in FIGS. 5A and 5B, compared to FIGS. 3 and 4, is that there are no separate adapter parts used. In FIGS. 5A and 5B, the vertical via 513 as a feed probe has the necessary ground openings for it that are made for the multilayer substrate 505. The vertical via 513 is used as a feed probe, and a grounding design on the multilayer PCB 505 is configured to electrically match a shape of the waveguide 501. The waveguide 501 has appropriate openings in it which allows it to be mounted (i.e. mountable), and soldered directly to the multilayer substrate 505. The waveguide 501 may have extensions used as solder pads 507. Soldering two parts, pieces, or components together is most efficient with flat surfaces on each of the parts/pieces/components. Solder is then placed between the flat surfaces. The ‘extensions’ discussed above relates to the extending of waveguide walls or conductive surfaces outside of the waveguide to form a flat surface, for soldering.

FIGS. 3 to 5 described above show examples of how to feed to RF signals into, or out of, a waveguide. Waveguides may also be fed through various other techniques, including through electric, magnetic and electro-magnetic coupling. Waveguides are typically excited to a ‘fundamental mode’. The fundamental mode of a waveguide is the mode that has the lowest cut-off frequency. However, waveguides may be excited to a higher-order mode, which allows the use of a physically larger waveguide at higher frequencies, when compared to the waveguide excited to the fundamental mode. This enables waveguides with ‘reasonable’ dimensions for manufacture to be used at high frequencies, such as for example, 100 GHz and THz ranges. Waveguides may also receive multiple feeds, and feeders used to excite the waveguide to different wave modes and/or at RF signals with different frequencies.

Electromagnetic compatibility (EMC) shielding is a method used to protect electronics from interfering electromagnetic signals (EMI). EMI can either be from an internal source (in a device) and/or an external source. Another function of the shielding is to prevent electromagnetic signals from leaking out of the device and interfering with other components in the same device, and/or component(s) of another device. Typical EMC shields, also known as a ‘shielding can’, used in wireless devices are printed circuit solderable metal cages. A metal cage may comprise two parts including a base, and a lid. Alternatively, the metal cage may comprise a solid shield consisting of one part. In some examples, shields/shielding cans comprise at least one aperture for heat dissipation. The at least one aperture for heat dissipation is sized so that certain frequencies cannot pass through the apertures, but the heat can pass through.

EMC shielding may be achieved by using a metallic screen/shield to absorb the EMI that is being transmitted through the air. The shield effect is based on a principle used in a Faraday cage, wherein the metallic screen completely surrounds either the sensitive electronics or the transmitting/receiving electronics. The screen absorbs the transmitted signals, and causes a current within the body of the screen. This current is absorbed by a ground connection, or a virtual ground plane.

For shielding on PCBs, which is sometimes referred to as board level shielding, the shielding typically consists of a PCB with a ground plane built into it, and a metal box (e.g. a shield can) that is placed over the sensitive or transmitting/receiving elements. The components are then (completely) surrounded by a Faraday cage arrangement.

Moreover, instead of using separate parts, EMC shielding may be implemented by using larger conductive mechanical parts. For example, a device internal frame or display frame is designed to have a cage/shield which is pressed over components on a PCB.

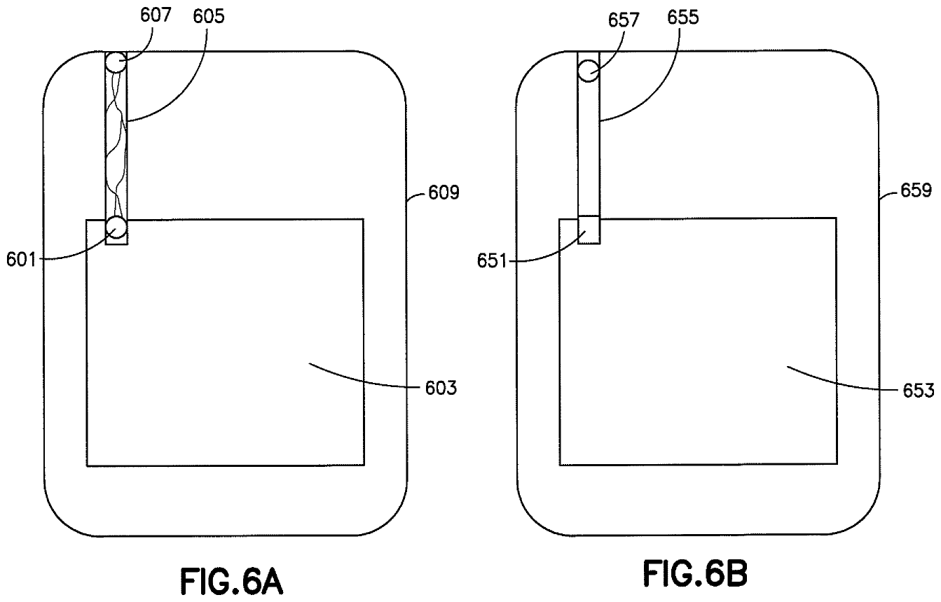

FIGS. 6A and 6B show schematic representations of a lightguide and an audio guide respectively.

A lightguide is a component used to direct light from a light source which is typically directed to a spot where light is output from the device. Lightguides are typically made of plastic with appropriate optical properties. An example for the use of a lightguide in a device is illustrated in FIG. 6A.

An LED 601 located at a PCB 603 of a device 609 is used as a light source. A lightguide 605 is used to convey the light to an upper part of the device where the light is then output 607 from the device 609.

An audio/acoustic guide is a sealed air channel designed to transfer audio signals/voice. Typically audio/acoustic guides are used to route audio signals from a microphone or an earpiece component to holes in a device enclosure to input and output voice e.g., in smartphones. An example for the use of an audio guide in a device is illustrated in FIG. 6B.

A microphone 651 is located at a PCB 653 of a device 659. An audio guide 655 is used to convey audio from an input/upper part 607 of the device 659 to the microphone 651 of the device 609.

‘Sealing’ is mechanically insulating or isolating a device. Sealing can be used to insulate different device parts from each other. Typically, sealing is achieved using dedicated mechanical parts, such as gaskets. Examples of sealing in a device, such as a mobile phone, is the sealing of an audio cavity from the rest of the device mechanics, or making the device water and/or dust proof with sealings.

The use of waveguides for RF signals are therefore useful in devices that communicate using higher frequencies, such as frequencies between 60 and 100 GHz, and above. This is likely to be the case for 3GPP UEs in 5G and beyond. However, by adding waveguides into devices, this will lead to an increased device size, increased weight and increased component price.

One or more of the following examples aim to address one or more of the problems identified above.

In examples, there is provided an apparatus with a waveguide arranged to guide electromagnetic waves, the waveguide comprising at least one conductive wall enclosing a waveguide path, wherein the waveguide is gas-filled. The apparatus also having a component with a conductive surface. The waveguide is integrated with the component, wherein the waveguide has at least part of the at least one conductive wall shared with the conductive surface of the component and at least another part of the at least one conductive wall that is non-shared.

In this way, there is provided a mechanical/electro-mechanical structure whereby a waveguide is integrated to one or more functional device parts.

In some examples, a waveguide is integrated to an EMC shield. In some examples, a waveguide is integrated to another conductive device (e.g., heatsink or display frame). In some examples, the integrated waveguide also comprises a waveguide antenna structure.

In some examples, an RF waveguide and an acoustic guide are integrated together. In some examples, an RF waveguide and a lightguide are integrated together.

In some examples, a waveguide is used as sealing gasket. In some examples, a waveguide is used as part of the sealing gasket structure.

These examples will be described in more detail below, alongside the following figures.

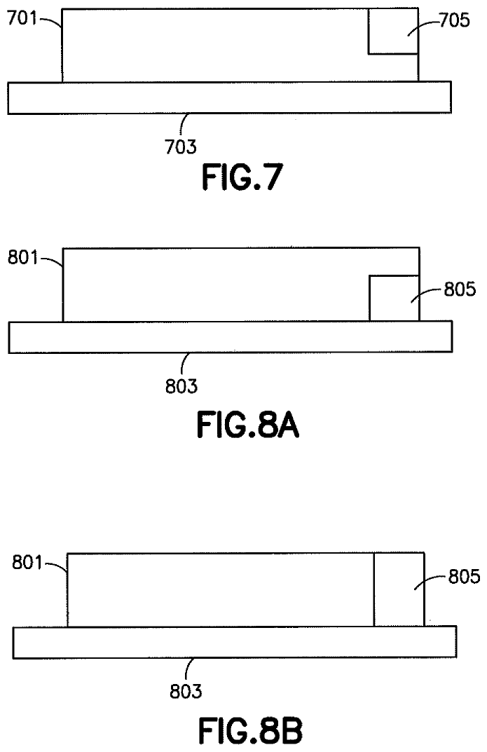

FIG. 7 shows a schematic representation of a waveguide integrated with an electromagnetic shield. FIG. 7 shows a cross-sectional view.

There is provided an EMC shield 701. The EMC shield 701 is mounted to a substrate 703. In this example, the substrate 703 is a PCB. There is also provided a waveguide 705, wherein the waveguide 705 is integrated with the EMC shield 701. In other examples, the EMC shield 701 is not mounted to a substrate 703.

In the example of FIG. 7, two walls of the waveguide 705 are shared with the EMC shield 701. The two other walls of the waveguide 705 are not shared with the EMC shield 701 (or any other components). These walls are referred to as non-shared walls. The waveguide 705 is at least partially enclosed within the EMC shield 701. In this way, the waveguide 705 is integrated to the EMC shield 701, or vice versa.

In this context, a ‘shared wall’ means that the waveguide 705 and the EMC shield 701 (or any other component) are integrated together.

In some examples, the waveguide 705 is fully enclosed within the EMC shield 701. In some examples, the waveguide 705 is partially enclosed as the waveguide 705 projects out of the EMC shield 701 wall to then extend to another shield or another component/module within the UE. This may be because there is a gap between the EMC shield 701 and, for example, an antenna (separate to the WG) which is formed on the inside surface of the housing of the UE, and so the WG will need to leave the EMC shield 701 and be shaped to end at the antenna.

The wall of the waveguide 705 may be conductive. In this context, conductive means electrically conductive. The wall may be formed of a solid conductive material, e.g. a conductive metal. In other examples, a surface of the wall may be coated with a conductive material. For example, a surface of a plastic wall may be coated with a conductive material,

In examples with other shaped waveguides, such as a circular waveguide (see FIG. 1), a part of the wall may be shared, with other parts of the wall being non-shared. A circular waveguide may be said to have a single wall.

The sharing of the wall with the shield 701 may mean that the waveguide 705 is attached to the shield 701 so that a wall of the component is in contact with the shared wall of the waveguide 705. The sharing of the wall with the shield 701 may also mean that the waveguide 705 is attached to the shield 701 so that the wall of the component forms the shared wall of the waveguide 705. Said another way, the shared wall is a wall of the waveguide 705 and of the shield 701. In this way, having a shared wall means that the waveguide 705 and of the shield 701 have a common wall.

In this example, the waveguide 705 is gas-filled. The gas may be, for example, air, nitrogen, helium, or any other suitable gas.

The waveguide 705 integrated with the EMC shield 701 may be comprised within a device. The device may be, for example, one of: a user device, a mobile device, a user equipment, a computer tablet, a laptop, machine to machine device, etc.

By providing a shared wall of the WG with another component (e.g. EMC shield), at least part of the WG and at least part of the other component may be manufactured by the MID and/or LDS techniques, and possibly other parts of the another component too

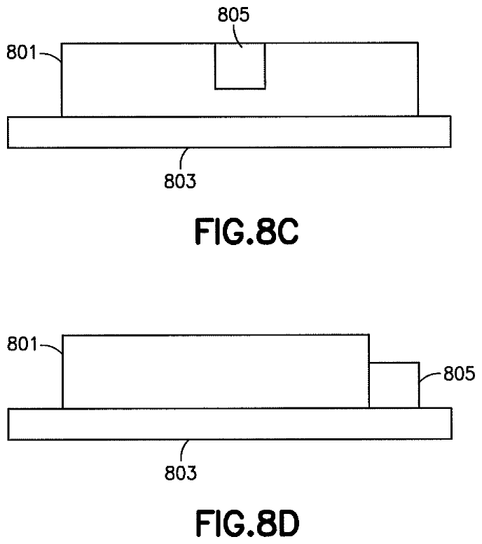

FIGS. 8A-8D show schematic representations of waveguides integrated with electromagnetic shields, in four different configurations. All four structures of FIGS. 8A-8D are cross-sectional views.

The structures shown in FIGS. 8A-8D are similar to that of FIG. 7, but with different arrangements of the waveguide with regard to the shield and substrate.

In FIGS. 8A-8D, there is provided an EMC shield 801. The EMC shield 801 is mounted to a substrate 803. In this example, the substrate 803 is a PCB. There is also provided a waveguide 805, wherein the waveguide 805 is integrated with the EMC shield 801.

FIG. 8A shows a structure wherein one wall of the waveguide 805 is formed by the EMC shield 801, another wall of the waveguide 805 is formed by the substrate 803, and two other walls of the waveguide 805 are specific for the waveguide. The wall of the waveguide 805 formed by the substrate may be formed using metal of the substrate, e.g. PCB metal, or another conductive surface. In this example, the waveguide 805 is enclosed within the EMC shield 801.

FIG. 8B shows a structure with two walls of the waveguide 805 being shared with the EMC shield 801. A third wall of the waveguide 805 is shared with the substrate 803, and a fourth wall is dedicated to the waveguide 805.

FIG. 8C shows a structure with one wall of the waveguide 805 being shared with the EMC shield 801, and three other walls dedicated to the waveguide 805.

FIG. 8D shows a structure that is similar to FIG. 8A, with exception the waveguide 805 is formed outside of the EMC shield 801.

As shown in FIGS. 8A-8D, for a rectangular shaped waveguide 805, the waveguide 801 may be arranged to share one or two walls with the EMC shield 801, and none or one wall with the substrate 803.

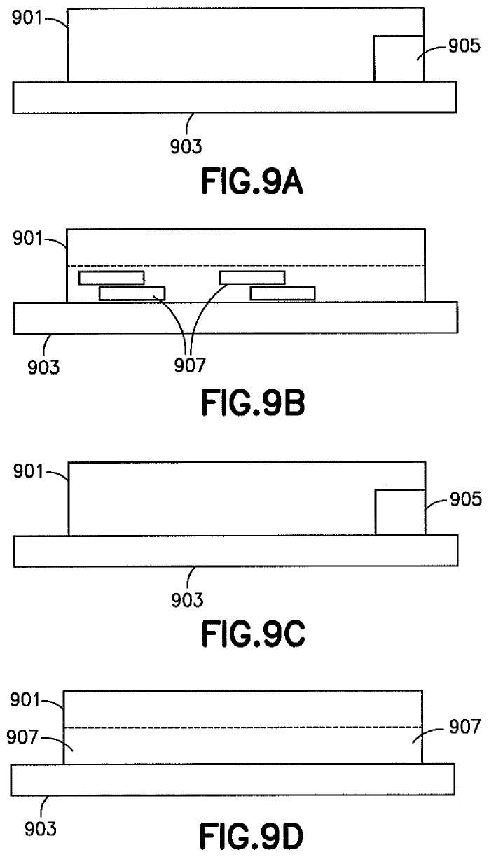

As shown in the examples above, waveguide structures can be used for RF/IF signal transfer inside a device. In addition to this, waveguide structures may include apertures which are used as an antenna, or as an antenna array. Examples of this are shown in FIGS. 9A-9D.

FIGS. 9A-9D show schematic representations of waveguides integrated with electromagnetic shields, with apertures in a waveguide wall.

The example structures of FIGS. 9A-9D are similar to the example of FIG. 8A, with the addition of apertures.

FIG. 9A shows a cross-sectional view of a structure. FIG. 8B shows a side view of the structure of FIG. 9A.

FIGS. 9A and 9B show a structure wherein one wall of a waveguide 905 is formed by an EMC shield 901, another wall of the waveguide 905 is formed by a substrate 903, and two other walls of the waveguide 905 are specific for the waveguide. The wall of the waveguide 905 formed by the substrate may be formed using metal of the substrate, e.g. PCB metal, or another conductive surface. In this example, the waveguide 905 is enclosed within the EMC shield 901.

There is also provided a plurality of apertures 907 in a wall of the waveguide 905. The plurality of apertures 907 are shown in FIG. 9B. The apertures 907 are in the wall shared between the waveguide 905 and the EMC shield 901. In this example, there are four apertures. In other examples, there are more or less than four apertures. In some examples, there is a single aperture.

The plurality of apertures 907 may be used as an antenna. In some examples, an antenna is provided per aperture 907.

FIG. 9C shows a cross-sectional view of a further structure. FIG. 9D shows a side view of that further structure of FIG. 9C. The further structure is open-ended. Open-ended means that there is not a wall at either, or both, of the ends of the waveguide.

FIG. 9D shows that the open-ends of the waveguide 905 are used as an aperture for an antenna. In the example of FIG. 9D, both ends of the waveguide 905 are open, meaning that there are two apertures 907. In other examples, only one end of the waveguide 905 is open-ended.

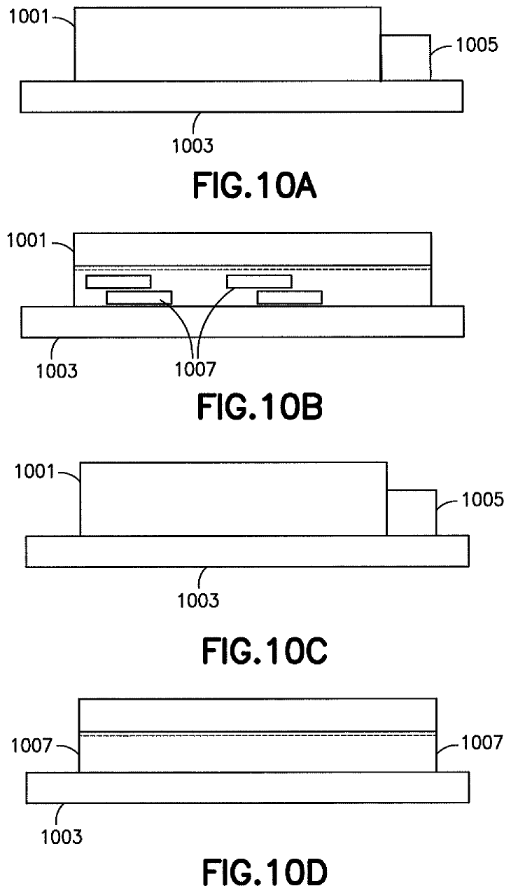

Example of structures where a waveguide is formed on the outside of the EMC shield are shown in FIGS. 10A-10D. In these examples, an aperture, or apertures, are formed in a wall of the waveguide wall that is dedicate to the waveguide (i.e. a non-shared wall). Similar to the structures of FIG. 9, the apertures may be located at a wall of the waveguide (i.e. in the side wall), or at an open-end of the waveguide, and may be used as an antenna.

FIGS. 10A-10D show schematic representations of waveguides integrated with electromagnetic shields, with apertures in a waveguide wall.

The example structures of FIGS. 10A-10D are similar to the example of FIG. 8D, with the addition of apertures.

FIG. 10A shows a cross-sectional view of a structure. FIG. 10B shows a side view of the structure of FIG. 10A.

FIGS. 10A-10B show a structure wherein one wall of a waveguide 1005 is formed by an EMC shield 1001, another wall of the waveguide 1005 is formed by a substrate 1003, and two other walls of the waveguide 1005 are specific for the waveguide (i.e. non-shared). The wall of the waveguide 1005 formed by the substrate may be formed using metal of the substrate, e.g. PCB metal, or another conductive surface. The waveguide 1005 is formed outside of the EMC shield 1001.

There is also provided a plurality of apertures 1007 in a wall of the waveguide 1005. The plurality of apertures 1007 can be seen in FIG. 10B. The apertures 1007 are in one of the non-shared walls of the waveguide 1005. In this example, there are four apertures. In other examples, there are more or less than four apertures. In some examples, there is a single aperture.

The plurality of apertures 1007 may be used as an antenna. In some examples, an antenna is provided per aperture 1007.

FIG. 10C shows a cross-sectional view of a further structure. FIG. 10D shows a side view of that further structure of FIG. 10C. The further structure is open-ended.

FIG. 10D shows that the open-ends of the waveguide 1005 are used as an aperture for an antenna. In the example of FIG. 10D, both ends of the waveguide 1005 are open, meaning that there are two apertures 1007. In other examples, only one end of the waveguide 1005 is open-ended.

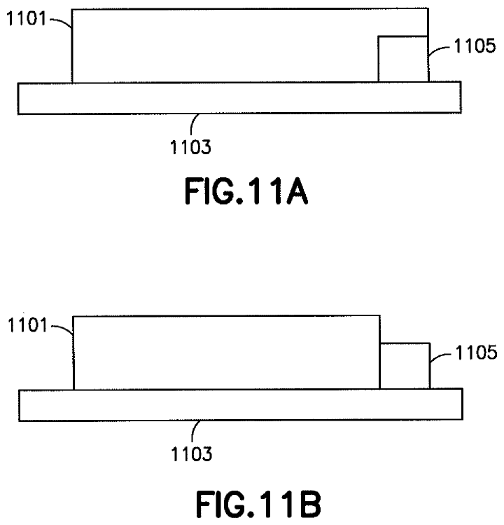

In other examples, an aperture (or a plurality of apertures) is formed in a wall of a waveguide shared with a surface of a substrate (e.g. PCB). This apply to examples whereby the waveguide is enclosed within an EMC shield, and when the waveguide is formed outside of the EMC shield. This is illustrated in FIGS. 11A-11B.

FIGS. 11A-11B show schematic representations of waveguides integrated with electromagnetic shields, with apertures formed in a waveguide wall shared with a substrate. Both FIGS. 11A-11B show cross-sectional views of the structures.

In FIG. 11A, there is provided a structure wherein one wall of a waveguide 1105 is formed by an EMC shield 1101, another wall of the waveguide 1105 is formed by a substrate 1103. Two other walls of the waveguide 1105 are specific for the waveguide (i.e. not shared with another component or part of the structure). The wall of the waveguide 1105 formed by the substrate 1103 may be formed using metal, or another conductive material, of the substrate 1103, e.g. PCB metal, or another conductive surface. The waveguide 1105 is enclosed within the EMC shield 1101.

There is also provided a plurality of apertures in the wall of the waveguide 1105 that is formed with the substrate 1103 (not shown). These apertures are not visible in FIG. 11A as they are on the bottom side of the structure. It should be understood that in other examples, only a single aperture is provided. Each aperture may be used as an antenna.

In FIG. 11B, there is provided a further structure wherein one wall of a waveguide 1105 is formed by an EMC shield 1101, another wall of the waveguide 1105 is formed by a substrate 1103. Two other walls of the waveguide 1105 are specific for the waveguide (i.e. not shared with another component or part of the further structure). The wall of the waveguide 1105 formed by the substrate 1103 may be formed using metal, or another conductive material, of the substrate 1103, e.g. PCB metal, or another conductive surface. The waveguide 1105 is formed outside of the EMC shield 1101.

There is also provided a plurality of apertures in the wall of the waveguide 1105 that is formed with the substrate 1103 (not shown). These apertures are not visible in FIG. 11A as they are on the bottom side of the further structure. It should be understood that in other examples, only a single aperture is provided. Each aperture may be used for an antenna.

The above examples show the integration of the waveguide with an EM shield. However, it should be understood that the integration of the waveguide is not limited to integrations with an EMC shield and substrate metals to form one or more walls of the waveguide. In other examples, waveguides are integrated with any conductive device part (or component with a conductive surface) including, for example and not limited to: a heat sink, a display, an antenna, a device internal support frame, or the like, or any permutation of their combination. In other examples, waveguides are integrated with, by sharing a common wall, with one of, for example: a lightguide, an audioguide, a heatsink, a frame for a display, an antenna, an antenna cable, a printed circuit board, a radio frequency cable, a battery, a connector, a frame for a connector, a frame for a camera, a frame for a battery, a metallic support frame, a support structure, a holder, a cover structure, a protection structure, a part used to protect the component

The phrase ‘conductive’ may mean any part that is composed from metal, or a dielectric part with a conductive coating/surface. Waveguides may have rectangular shape (as shown in FIGS. 7 to 11). In other examples, the waveguides are circular, square, elliptical, triangular, or any other suitable shape. Waveguide can be gas-filled, air-filled or filled with a dielectric material. Air-filled waveguide apertures may be used as antennas and may be located at one or more surfaces of the waveguide. This principle for apertures as antenna is also applicable to dielectric-filled waveguides.

In some examples, a lightguide and RF waveguide are integrated or combined with each other. This is also applicable to audio/acoustic guides. In some examples, an audio guide and RF waveguide are integrated, or combined, with each other. The combination may comprise a same channel of a waveguide being used to guide both light and RF/IF, or sound and RF/IF. Said another way, the waveguide has a single path, as air-filled or dielectric-filled, whereby the single path is arranged to guide both light and RF/IF, or sound and RF/IF. In other examples, two separate waveguides are integrated together by having two separate waveguides attached together, and sharing a common wall (or at least part of a common wall). One of the two waveguides guides light or sound, and the other of the two waveguides guides RF/IF.

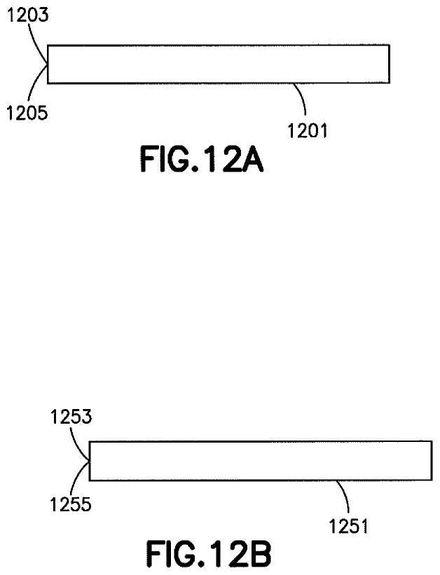

FIG. 12A shows a schematic representation of an RF/IF waveguide integrated with a lightguide.

In FIG. 12A, there is provided an integrated lightguide and RF waveguide 1201. The integrated lightguide and RF waveguide 1201 has a single path (or channel). An optical signal 1203 is input into the lightguide and RF waveguide 1201. An RF signal 1205 is also input the lightguide and RF waveguide 1201.

FIG. 12B shows a schematic representation of an RF/IF waveguide integrated with an audio guide.

In FIG. 12B, there is provided an integrated audio guide and RF waveguide 1251. The integrated audio guide and RF waveguide 1251 has a single path (or channel). An audio signal 1253 is input into the audio guide and RF waveguide 1251. An RF signal 1255 is also input the audio guide and RF waveguide 1251.

Having a single waveguide that is configured to guide both RF/IF and either light or audio will save on space and price/costs, compared to two separate waveguides.

As discussed above, in other examples, the integrated lightguide and RF waveguide 1201 and/or integrated audio guide and RF waveguide 1251 is formed of two separate waveguides attached/connected together with at least part of a wall shared between the two waveguides. One of the two waveguides guides light or sound, and the other of the two waveguides guides RF/IF. By having a shared wall between the two waveguides, this will save on space and costs, compared to two separate waveguides.

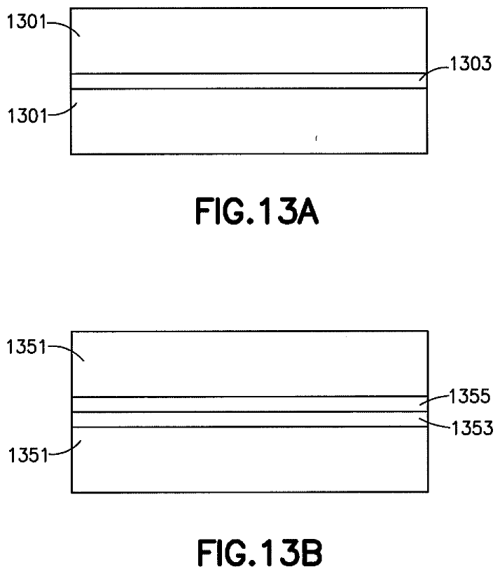

In some examples, waveguide structures are used as part of mechanical sealing. Examples showing an internal waveguide being used as a mechanical sealing structure between two mechanics parts is illustrated in FIGS. 13A-13B. An example structure can be such that a waveguide is used between two mechanical parts (e.g. FIG. 13A). Alternatively, a waveguide is used in addition to other sealing materials and thus combined with the other sealing materials. An example of a sealing material is, for example, a dielectric gasket. Sealing is performed for mechanically insulating or isolating a device. Sealing can be used to insulate different device parts from each other.

In other examples, a waveguide structure is used to seal between two electro-mechanical parts.

FIGS. 13A and 13B show schematic representations of waveguides being used for mechanical sealing.

In FIG. 13A, there are provided two mechanical parts 1301. There is also provided a waveguide 1303. The waveguide 1303 is situated between the two mechanical parts 1301. The waveguide 1303 is arranged to seal between the two mechanical parts 1301. In this way, the waveguide 1303 is ‘sandwiched’ between the two mechanical parts 1301. The waveguide 1301 is attached, and thus in contact with, both mechanical parts 1301.

In FIG. 13B, there are provided two mechanical parts 1351. There is also provided a waveguide 1353. There is also provided other sealing material 1355. The waveguide 1353 and the other sealing material 1355 is situated between the two mechanical parts 1351. The waveguide 1353 and the other sealing material 1355 are arranged to seal between the two mechanical parts 1351. In this way, the waveguide 1353 is ‘sandwiched’ between one of the two mechanical parts 1351 and the other sealing material 1355. The waveguide 1351 is attached to one of the two mechanical parts 1351 and the other sealing material 1355. The waveguide 1351 and the other sealing material 1355 together seal between the two mechanical parts 1351.

The waveguides 1301 and 1351 of FIGS. 13A and 13B may be waveguides for guiding RF/IF, light, and/or sound.

In examples, there is an apparatus comprising: a waveguide arranged to guide electromagnetic waves, the waveguide comprising at least one conductive wall enclosing a waveguide path; and two mechanical parts, wherein the waveguide is arranged between the two mechanical parts, to seal between the two mechanical parts. In some examples, the waveguide is in contact with both of the two mechanical parts. In some examples, the apparatus also comprises sealing material, wherein the sealing material is arranged between the two mechanical parts, and wherein the sealing material is in contact with one of the two mechanical parts and the waveguide. In some examples, the sealing material comprises a dielectric gasket. In some examples, the waveguide is one of: gas-filled, air-filled and dielectric filled.

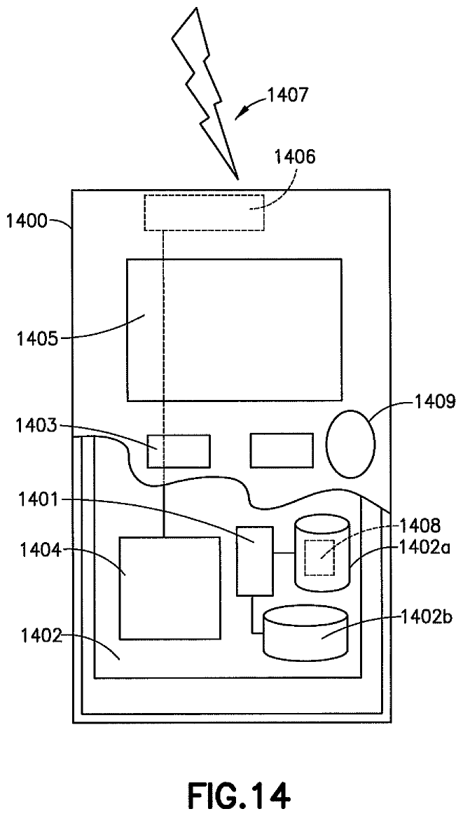

FIG. 14 shows a schematic representation of a terminal 1400. The terminal 1400 may be any device capable of sending and/or receiving signals. Non-limiting examples of the terminal 1400 include a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 1400 may provide, for example, communication of data for carrying communications. The communications may be one or more of voice, electronic mail (email), text message, multimedia, data, machine data, and so on.

The terminal 1400 may receive signals over an air or radio interface 1407 via an appropriate apparatus for receiving, and may transmit signals via an appropriate apparatus for transmitting radio signals. In FIG. 14, a transceiver apparatus is designated schematically by block 1406. The transceiver apparatus 1406 may be provided by, for example, means of a radio part and associated antenna arrangement. In other examples, the transceiver may be replaced by only receiver circuitry or only transmitter circuitry. The antenna arrangement may be arranged internally and/or externally to the mobile device. In some examples, the terminal 1400 has a plurality of transceivers 1406. For example, one or more transceivers for 3GPP radio access, one for more transceivers for Wi-Fi, a transceiver for global navigation satellite system, a transceiver for Bluetooth, a transceiver for near field communication, or the like. Transceivers and/or receivers may be integrated with each other.

The terminal 1400 comprises with at least one processor 1401, at least one memory ROM 1402a, at least one RAM 1402b and other possible components 1403 for use in software and hardware aided execution of tasks it is designed to perform, including control of access to and communications with access systems and other communication devices. The at least one processor 1401 is coupled to the RAM 1402b and the ROM 1402a. The at least one processor 1401 may be configured to execute an appropriate software code 1408. The software code 1408 may for example allow to perform one or more of the present aspects. The software code 1408 may be stored in the ROM 1402a.

The terminal 1400 also comprises processor peripherals 1409. The processor peripherals 1409 may comprise at least one of: at least one camera, device alternating-current (AC) powering, at least one battery (and their charging), at least one sensor, at least one connector, at least one light emitting diode, at least one button, at least one keypad, at least one display, at least one touchscreen, at least one audio and/or haptics components such as speakers and microphones, vibrators and the likes.

The processor, storage and other relevant control apparatus may be provided on an appropriate circuit board and/or in chipsets. This feature is denoted by reference 1404. The device may optionally have a user interface such as keypad 1405, touch sensitive screen or pad, combinations thereof or the like. Optionally one or more of a display, a speaker and a microphone may be provided depending on the type of the device.

The terminal 1400 of FIG. 14 may comprise one or more of the integrated waveguide structures, as described in any of FIGS. 7 to 13 (not shown).

One or more of the examples discussed above have the advantages that when a waveguide structure is integrated with one or more other components in a structure, a reduced number of device parts are required. This leads to the advantage of a smaller device size, and a lower device cost, when compared to solutions where non-integrated internal waveguides are used. This is of particular importance in devices whereby internal space is at a premium such as in user devices including mobile phones, user equipments, smartphones, and tablets. Furthermore, by integrating a waveguide structure(s) with one or more other component(s) means that a device is comprised of fewer parts, and is therefore easier and/or faster to assemble in a factory. It is also easier for related logistics and inventory. Integrated waveguide structures enables the use of shorter waveguide lengths with lower radio signal attenuation, compared to separate waveguide parts which may be longer in length as they will need to be routed around other components (and not integrated with them).

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used herein, “at least one of the following: <a list of two or more elements>” and “at least one of: <a list of two or more elements>” and similar wording, where the list of two or more elements are joined by “and”, or “or”, mean at least any one of the elements, or at least any two or more of the elements, or at least all of the elements.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus, comprising:
a waveguide arranged to guide electromagnetic waves, the waveguide comprising at least one conductive wall enclosing a waveguide path, wherein the waveguide is gas-filled; and
a component with a conductive surface;
wherein the waveguide is integrated with the component, wherein the waveguide has at least part of the at least one conductive wall shared with the conductive surface of the component and at least another part of the at least one conductive wall that is non-shared.

2. The apparatus according to claim 1, wherein the at least part of the at least one conductive wall shared with the component comprises:
the waveguide attached to the component so that at least part of a wall of the component is in contact with the at least part of the at least one conductive wall of the waveguide, and
the waveguide attached to the component so that the at least part of the wall of the component forms the at least part of the at least one conductive wall of the waveguide.

3. The apparatus according to claim 1, wherein the waveguide comprises a plurality of conductive walls, wherein the at least part of the at least one conductive wall shared with the component comprises: at least one wall of the plurality of conductive walls that is shared with the conductive component, and wherein the at least another part of the at least one conductive wall that is non-shared comprises: at least one wall of the plurality of conductive walls that is non-shared.

4. The apparatus according to claim 1, wherein the component is one of: an electromagnetic shield, a lightguide, an audioguide, a heatsink, a frame for a display, an antenna, an antenna cable, a printed circuit board, a radio frequency cable, a battery, a connector, a frame for a connector, a frame for a camera, a frame for a battery, a metallic support frame, a support structure, a holder, a cover structure, a protection structure, or a part used to protect the component.

5. The apparatus according to claim 4, wherein, when the conductive component is an electromagnetic shield, the waveguide is integrated with the electromagnetic shield,
wherein the waveguide has at least part of the at least one conductive wall shared with the electromagnetic shield, and
wherein at least another part of the at least one conductive wall is non-shared, such that at least part of a conductive wall is shared between the waveguide and the electromagnetic shield.

6. The apparatus according to claim 4, wherein the waveguide is one of: enclosed within the electromagnetic shield, partially enclosed within the electromagnetic shield, located outside of the electromagnetic shield, or partially located outside of the electromagnetic shield.

7. The apparatus according to claim 1, wherein the waveguide is arranged to guide at least one of light or sound waves as well as the electromagnetic waves.

8. The apparatus according to claim 1, wherein the waveguide comprises at least one aperture in the at least one conductive wall, the at least one aperture arranged to be used as at least one antenna.

9. The apparatus according to claim 1, wherein the waveguide is arranged as an open-ended waveguide, the open-end of the waveguide arranged to be used as an antenna.

10. The apparatus according to claim 1, wherein the apparatus comprises a feed probe which is arranged to be inserted into an opening of the waveguide.

11. The apparatus according to claim 1, wherein the apparatus comprises a substrate, wherein the conductive component is mounted to the substrate.

12. The apparatus according to claim 11, wherein the waveguide is integrated with the substrate, the waveguide having at least part of the at least one conductive wall shared with the substrate.

13. The apparatus according to claim 12, wherein the waveguide is attached to the substrate so that the at least part of a wall of the substrate forms at least part of at least one conductive wall of the waveguide.

14. The apparatus according to claim 12, wherein the at least part of the at least one conductive wall that is shared with the substrate comprises at least one aperture, the at least one aperture arranged to be used as at least one antenna.

15. The apparatus according to claim 1, wherein one of: the apparatus is for a user device, the apparatus is comprised in the user device, or the apparatus is the user device.
